(19) United States
(12) Patent Application Publication
(10) Pub. No.: US 2007/0025032 A1
(43) Pub. Date: Feb. 1, 2007

(54) LCDI with isolated detection and interruption

(76) Inventors: Roger M. Bradley, North Bellmore, NY (US); Thomas Keating, Rockville Centre, NY (US)

Correspondence Address: PAUL J. SUTTON, ESQ., BARRY G. MAGIDOFF, ESQ.;GREENBERG TRAURIG, LLP, 200 PARK AVENUE, NEW YORK, NY, 10166, US

(21) Appl. No.: 11/404,336

(22) Filed: Apr. 13, 2006

Related U.S. Application Data
(60) Provisional application No. 60/672,119, filed on Apr. 14, 2005.

(51) Int. Cl. H02H 9/08

(52) U.S. Cl. 361/42; 361/93.1

(57) ABSTRACT

An LCDI circuit interrupting device having a detection portion and an interrupting portion coupled to each other with a device that isolates each said portion thus allowing the detection portion to detect electric faults based on a threshold voltage that is independent of the threshold voltage used by the interrupting portion to trip the device.

This application claims the benefit of the filing date of a provisional application having serial No. 60/672,119 which was filed on Apr. 14, 2005.

### BACKGROUND OF THE INVENTION

1. Field of the Invention

The present invention relates to circuit interrupting devices.

2. Description of the Related Art

A Leakage Current Detector Interrupter (LCDI) is a type of circuit interrupting device that detects a short circuit between conducting materials (e.g., wires, shield) of a power cord. A typical LCDI device comprises a housing having a three prong plug and a power cord. The power cord emanates from the housing and typically is directly connected to an electrical household device (e.g., air conditioner unit, refrigerator, computer). The plug is used for a standard connection to an AC (Alternating Current) outlet that provides power. Thus, when the plug is connected to an electric power source (e.g., AC outlet) electrical power is provided to the device via the LCDI and the power cord connected thereto. The power cord typically comprises a hot or phase wire, a neutral wire and a ground wire each of which is insulated. All three wires are enclosed or are wrapped by a shield which is made of electrically conducting material that is typically not insulated. The shield and the wires are all enclosed in an insulating material (e.g., rubber or similar type material) thus forming the power cord. Circuitry residing within the housing detects electrical faults resulting from electrical shorts that occur between any of the wires and the shield. When an electrical fault is detected the circuitry trips the LCDI causing the LCDI to disconnect power from the power cord and the device eliminating a hazardous condition. In particular, a circuit interrupting device such as an LCDI device is designed to prevent fires by interrupting the power to the cord, if current is detected flowing from the phase, neutral or ground wires (in the cord) to the shield within the cord. This flow of current may be caused by degradation of the insulation around the wires due to arcing, fire, overheating, or physical or chemical abuse. The current flowing between any of the wires and the shield is referred to as leakage current.

The LCDI circuitry residing within the housing typically comprises, amongst other circuits, a fault detecting circuitry and a mechanism which trips the LCDI when an electrical fault is detected. The detection portion detects the existence of an electrical fault (e.g., arcing, electrical short across between damaged wires of the power cord) based on a first threshold voltage. An electrical fault is any set of circumstances that results in current flow between either the phase, neutral or ground wires of an electrical cord and the conductive shield of that cord. Once an electrical fault is detected, the tripping mechanism causes the LCDI to be disconnected from the power supply based on a second threshold voltage. A problem arises in that the first and second thresholds are usually incompatible with each other from a design standpoint. For many LCDI devices the first threshold voltage is preferably located halfway between the phase and neutral voltages and the second threshold voltage is preferably located near either the phase or the neutral voltages. It therefore becomes very difficult to meet both threshold voltage preferences when the entire circuitry (including the detection portion and the interrupting portion) of the LCDI device has one point of reference which is usually a circuit ground.

### SUMMARY OF THE INVENTION

The present invention is a circuit interrupting device designed to detect leakage currents between conductors in a wire. The circuit interrupting device comprises a detection portion and an interrupting portion. The detection portion is configured to detect electrical faults and generate a fault detection signal which is applied to a nonconductive coupling device which couples said detection portion to said interrupting portion. The coupling device transfers the fault signal to the interrupting portion in a nonconductive manner allowing the interrupting portion to trip the circuit interrupting device based on a threshold voltage that is independently determined from any threshold voltage used by the detection portion to detect the electrical fault.

### BRIEF DESCRIPTION OF THE DRAWINGS

FIG. 1 is a circuit diagram of 120V LCDI of the present invention.

FIG. 2 is a circuit diagram of a 240V LCDI of the present invention.

FIG. 3 is a perspective view of the outer housing of the LCDI of the present invention.

FIG. 4 is a perspective of the internal structure of the LCDI of the present invention.

FIG. 4A is FIG. 4 cut along line A-A′.

FIG. 4B is a side view of FIG. 4 cut along line A-A′.

### DETAILED DESCRIPTION

The present invention is a circuit interrupting device designed to detect leakage currents between conductors in a wire. The circuit interrupting device comprises a detection portion and an interrupting portion. The detection portion is configured to detect electrical faults and generate a fault detection signal which is applied to a nonconductive coupling device which is coupled to said detection portion and said interrupting portion. The coupling device transfers the fault signal to the interrupting portion in a nonconductive manner allowing the interrupting portion to trip the circuit interrupting device based on a threshold voltage that is independently determined from any threshold voltage used by the detection portion to detect the electrical fault.

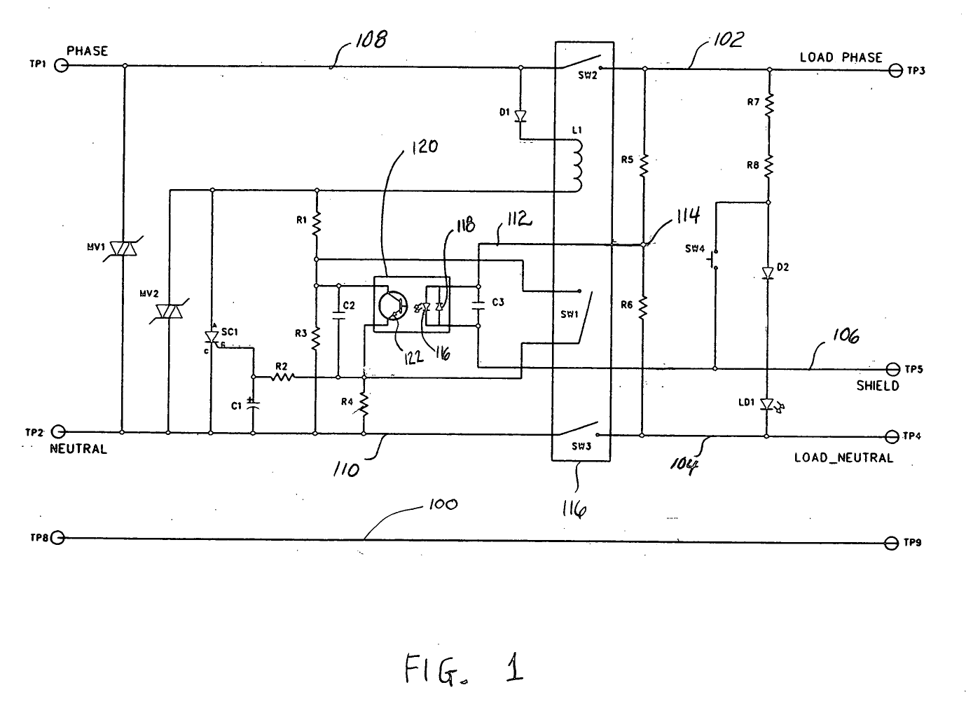

The present invention improves upon previous LCDI designs by isolating the detection and circuit interrupting portions of the device; this allows each of the two sections to operate based on desirable threshold voltages that are derived independent of each other. It should be noted that the term “connection” used throughout this specification is understood to refer to any electrically conducting material, component or combination thereof that provide an electrical connection between at least two designated points or between at least two electrical components. FIG. 1 shows the schematic of a circuit for a 120V version of the present invention.

Referring to FIG. 1, the circuit is powered from line phase and line neutral of an AC supply, through the blades (not shown in FIG. 1) of the plug of the LCDI device of the present invention. Two of the blades are electrically connected to connection points TP1 and TP2 of FIG. 1. There may also be a third connector/blade or ground connection to the receptacle or housing; that connector is electrically connected to connection point TP8 which is ground. Connection point TP8 is connected directly to point TP9 (via connection 100) neither one of which is connected to the circuitry of the LCDI as shown in FIG. 1. The circuitry shown is also connected to a power cord (not shown), which is an integral part of the device, at point TP3 and TP4. The power cord has at least two wires and a shield. Many devices use a power cord with three wires wherein one of the wires is a ground wire. For the sake of explanation, the LCDI device whose schematic is shown in FIG. 1 is assumed to have three wires in its power cord. However, it should be noted that the present invention is not limited to a three wire LCDI device. A first wire (hot or phase) is connected to connection point TP3 (and thus connection 102) and a second wire (neutral) is connected to connection point TP4 and thus connection 104. A third or ground wire is connected to connection point TP9. The shield is a conductive material wrapped around the wires (or which encloses all three wires) and is electrically connected to connection point TP5 and thus connection 106. The three wires and the shield are all enclosed in an insulator material and thus the cord is formed.

A review of FIG. 1 shows that the first wire being electrically connected to TP3 is also electrically connected to TP1 via connection 102, switch contact SW2 when SW2 is in a closed position and connection 108. Similarly, the second wire being electrically connected to TP4 is also electrically connected to TP2 via connection 104, switch contact SW3 when SW3 is in a closed position and connection 110. The third wire being electrically connected to TP9 is electrically connected to TP8 via connection 100. Although the first wire, second and third wires, the shield and the insulator are not shown in FIG. 1, it will be clear to one of ordinary skill in the art to which this invention belongs these respective components of the power cord can be electrically connected to TP3, TP4, TP5 and TP9 respectively as described above using well known techniques.

The circuit shown in FIG. 1 comprises a detection portion and an interrupting portion. The detection portion comprises shield connection 106, resistors R5 and R6, connection 112 and capacitor C3 and LEDs (Light Emitting Diodes) 116 and 118 which form part of a nonconductive coupling device 120. The particular nonconductive coupling device shown is an optoisolator. An optoisolator (sometimes referred to as a photocoupler) is a device that converts its electrical signal input to an optical signal by its input circuitry. The optical signal is detected by a photodetector portion (transistor or photodetector 122 and associated circuitry not shown) of the optoisolator which converts the optical signal back to an electrical signal. The key characteristic of the optoisolator and nonconductive coupling devices in general, is that the input signal to the device (whether processed or not) is transferred to the output of the device in a nonconductive manner. In many nonconductive coupling devices, there is no conductive path (electrical wires or other concrete conducting material) from the input through internal circuitry of the device to the output of the device. The device is able to conduct electricity in each of its input and output sections, but the transfer of signals from its input section to its output section is done in a nonconductive manner. Another example of a nonconductive coupling device is an electrical transformer. Thus, the transfer of the signal from input to output can be done, for example, optically (in the case of an optoisolator) or electromagnetically (in the case of a transformer). The nonconductive coupling device 120 thus isolates the detection portion from the interruption portion of the LCDI of the present invention. When an electrical fault occurs a fault signal is generated by the detection circuitry and said fault signal is applied to the input of a nonconductive coupling device which transfers said signal in a nonconductive manner to the interrupting portion allowing said interrupting portion to trip the LCDI. In the embodiment shown and discussed herein the LCDI is tripped when a coil of a solenoid is energized or activated.

Connections 106 and 112 also form part of the detection portion and are the inputs to the optoisolator 120. The input circuitry of optoisolator 120 comprises at least LEDs 116 and 118. Resistors R5 and R6 form a bias circuit and their values are chosen so that the voltage at point 114 (junction of R5 and R6) is set halfway between the voltage at conductor 102 and conductor 104. For example, if voltage at conductor 102 is +10 v and the voltage at conductor 104 is 0 v, then the voltage at point 114 is 5 v, halfway between 0 volt and 10 volts. Thus, resistors R5 and R6 bias the shield at a first threshold voltage that is halfway between the voltages of the phase and neutral conductors.

The interrupting portion of the circuitry shown in FIG. 1 comprises resistors R1, R2, R3, R4 and capacitors C1 and C2. The interrupting portion further comprises the output portion of optoisolator 120, (i.e., at least transistor or photodetector 122), silicon control rectifier SC1, coil L1, diode D1 and switch contacts SW2 and SW3. It should be noted that LED's 116 and 118 and transistor 122 represent a symbolic schematic of the optoisolator device 120 with the understanding that there may be additional circuitry in this device that is not shown. Also, L1 is part of a solenoid coil assembly 116 which includes switch contacts SW2, SW3 and SW1. The switch contacts SW2 and SW3 are activated (to close or open) when the solenoid coil L1 is energized.

The LCDI device thus serves to disconnect the load connections (TP3 and TP4) from the line connections (TP1 and TP2) when an electrical fault occurs. In short, when degradation of the insulator around the cord's conductors (due to physical abuse, thermal or chemical action) is sufficient to allow current to flow from the phase conducting path (TP3 and conductor 102), neutral conductive path (TP4 and conductor 104) or ground wire 100 to the shield (TP5 and conductor 106), then the device trips: isolating the power cord from the supply.

As described above, the LCDI of the present invention allows the reference voltage for the detection portion to be set independently of the reference voltage for the interrupting portion. For example when an LCDI is powered from a single-phase 120V supply with the neutral wire connected to the ground or reference for the power supply (this is usually the outer metallic enclosure of an electrical panel from which power for a household originates), the preferred potential or threshold voltage value set for shield is directly between the phase and neutral voltages. This allows equal sensitivity to leakage current from the phase, neutral and ground conductors. However this potential is incompatible with the voltage required for many interrupting mechanisms. In particular: the electro mechanical arrangement used by many circuit interrupting devices such as LCDIs prefer that the electrically controlled switch (typically an SCR such as SC1) turn on the trip coil at a reference potential or threshold voltage that is relatively close to either the phase or neutral voltage. An electrically controlled switch is an electrical (semiconductor or metallic or both) component which allows current flow (in one direction or both directions) through it based on a control voltage applied its control input. Examples of electrically controlled switches include, but are not limited to, SCRs and transistors. Biasing the shield to a voltage (i.e., a first threshold) halfway between the phase and neutral voltages allows equal sensitivity to leakage current from the phase, neutral and ground conductors. Biasing the gate voltage of the SCR so that the SCR turns ON at a voltage (i.e., a second threshold) that is relatively near either the phase or neutral voltages is a desirable feature for the particular electromechanical interrupting scheme used in the LCDI of the present invention.

Still referring to FIG. 1, the resistance values of R5 and R6 are relatively large, limiting the current that flows through the shield when an electrical fault occurs. Noise filtering, on the detection side, is provided by capacitor C3, which is in parallel with the LED side of the optoisolator 120. At relatively high frequencies, C3 acts like a short circuit; thus current to or from the shield flows between conductors 112 and 106 directly. At line frequencies (e.g., 60 Hz) C3 is high impedance and the majority of any current in conductors 112 and/or 106 flows through the LEDs 116, 118 of the optoisolator. Consequently, high frequency current spikes will not turn on the LEDs 116, 118 in the optoisolator, but line frequency current will.

The detection portion of the circuit works in the following fashion. Assuming SW2 and SW3 are closed, if an electrical connection is made between load phase TP3 and the shield TP5 (due to damaged wires, for example) then AC current (i.e., leakage current) flows through connection 106 to LEDs 116, 118 in the optoisolator 120 and through R6 to connection 104 and thus to load neutral TP4. Alternatively, if an electrical connection is made between load neutral TP4 (or ground TP9) and the shield TP5 then AC current (i.e., leakage current) flows through the LEDs 116, 118 in the optoisolator 120 and through R5 to connection 102 and thus to load phase TP3. In either situation of leakage current flow, the current flow through the LEDs 116, 118 causes them to illuminate which causes transistor 122 on the interruption side of the optoisolator 120 to turn ON.

The transistor section of the optoisolator is supplied with DC voltage from the circuit consisting of diode D1, trip coil L1 and the resistor divider R1 and R3, but only when line phase TP1 (including connection 108) is positive with respect to line neutral TP2 (including connection 110). Therefore, current can only flow through the transistor during the positive half cycle of AC current. When the transistor is turned ON (by the LEDs in the optoisolator), current flows through it from the DC power supply and voltage appears across resistor R4. The voltage across R4 is applied to a RC network comprising resistor R2 and capacitor C1. The values of R2 and C1 are chosen so that the transistor must be ON for a defined time period before the voltage across C1 reaches the gate voltage of SC1. This adds a lot of noise immunity to the device as short-lived pulses will not trip it. It also determines when the trip coil L1 will fire in the positive half cycle. The defined time period can range from microseconds to several milliseconds. The particular voltage at which SC1 is turned ON is the second threshold.

When sufficient voltage and current have reached the gate of SC1 to turn it ON, it starts conducting, allowing current to flow through the solenoid coil L1 thus energizing said coil and activating the solenoid. In particular the switch contacts SW2 and SW3 are activated. When the solenoid is activated it trips open the contacts SW2 and SW3, thus removing power from the cord. Opening the contacts also removes the leakage current and the signal at the gate of the SCR. When the AC voltage reaches the next zero crossing (with no gate signal on the SCR), the SCR stops conducting. The circuit is now ready to be reset.

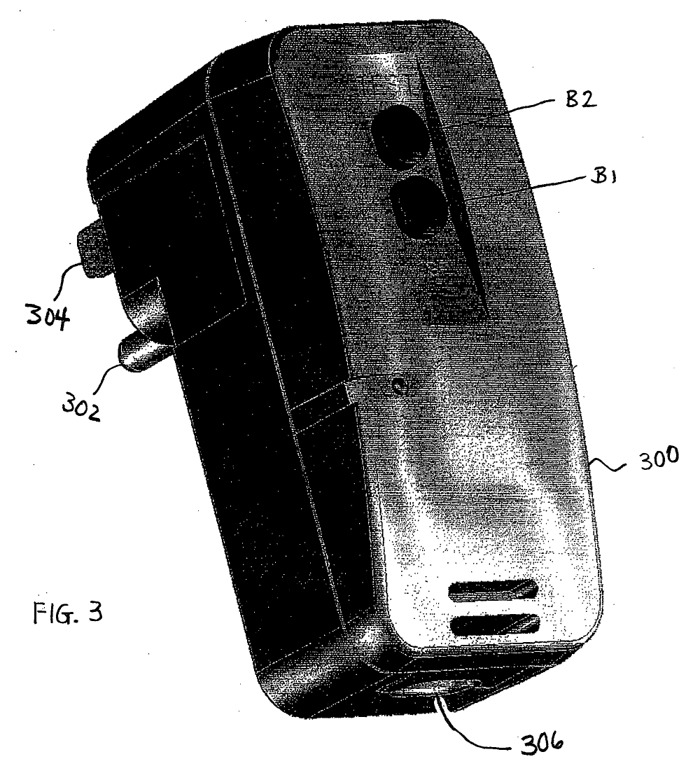

To reset the device, the user must physically depress a reset button (B1 of FIG. 3) on the exterior of the device. The reset button is shown as SW1 in FIG. 1. Upon pressing the reset button, the normally open, internal momentary switch SW1 is closed. The internal mechanical arrangement of the LCDI of the present invention is such that SW1 can only be closed when the device is in its tripped state and the reset button is pressed. In particular, when SW1 is closed, current flows through a resistor divider consisting of R1 and R4 allowing the RC network of R2 and C1 to charge up to a sufficient voltage to turn ON SC1. When SC1 turns on, the solenoid L1 is energized activating the switch contacts to reset the device. As will be discussed below, the device will not reset if any one of the various components of the detection and interruption portion are not functioning properly; this is the reset lockout feature of the LCDI. The electromechanical arrangement of the LCDI thus provides for a reset lockout feature that prevents the device from being reset if any one or more of the components of the detection and interrupting portion (circuitry and mechanical components) are not functioning properly. SW1 is self-clearing in that it returns to its normally open position when the solenoid fires and the reset mechanism moves past the reset lock out. When the reset button is released, the main switch contacts SW2 and SW3 close. The device is now in its reset state. Note that if a fault condition is still present, the device will immediately trip.

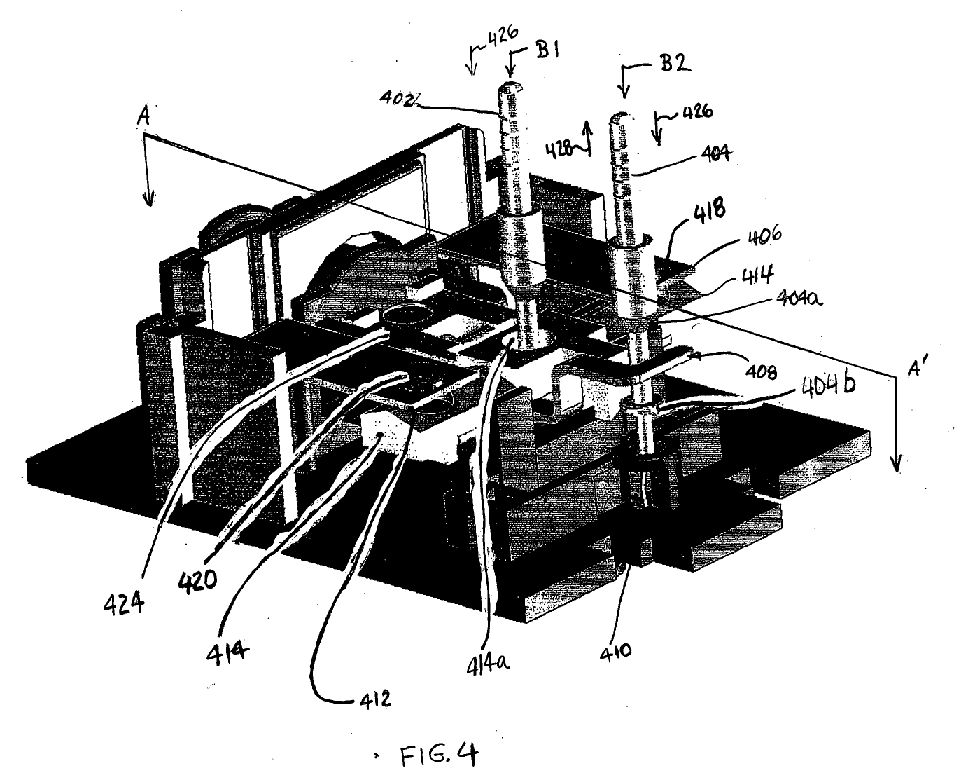

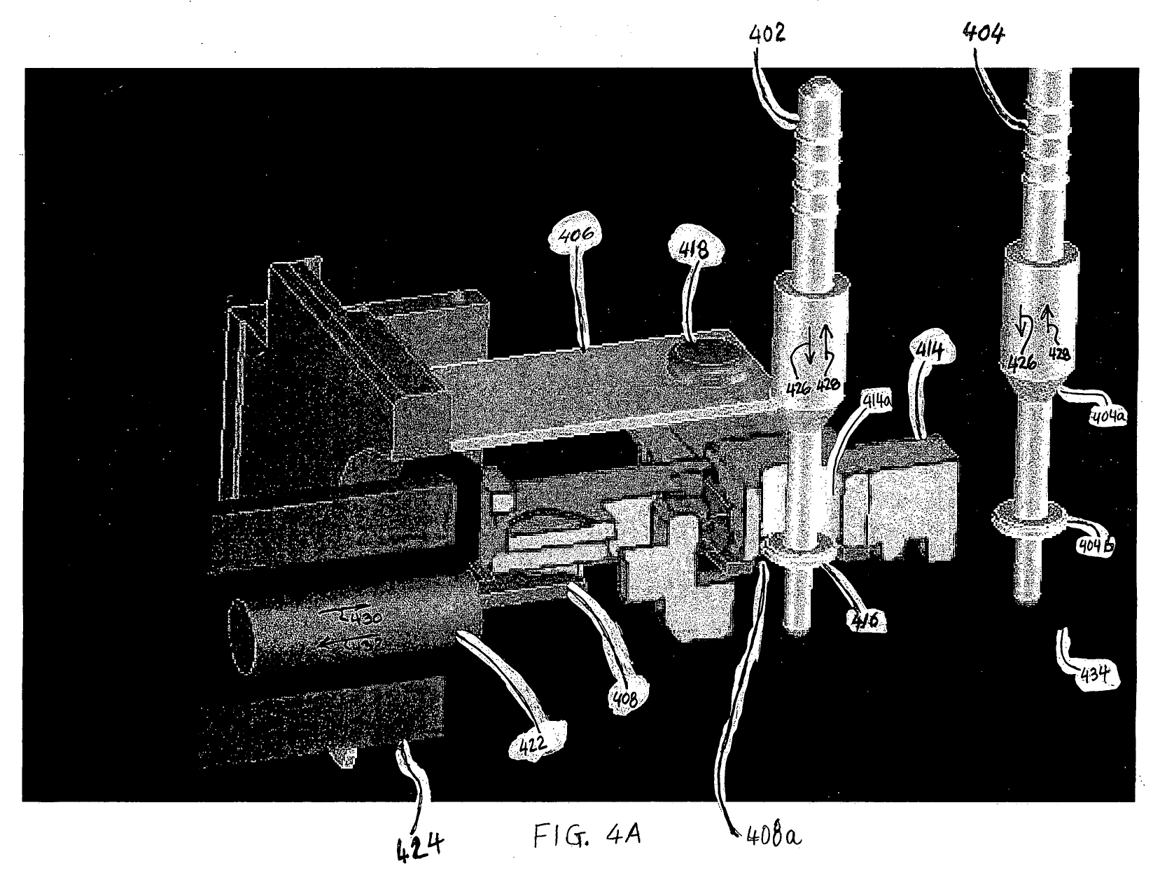

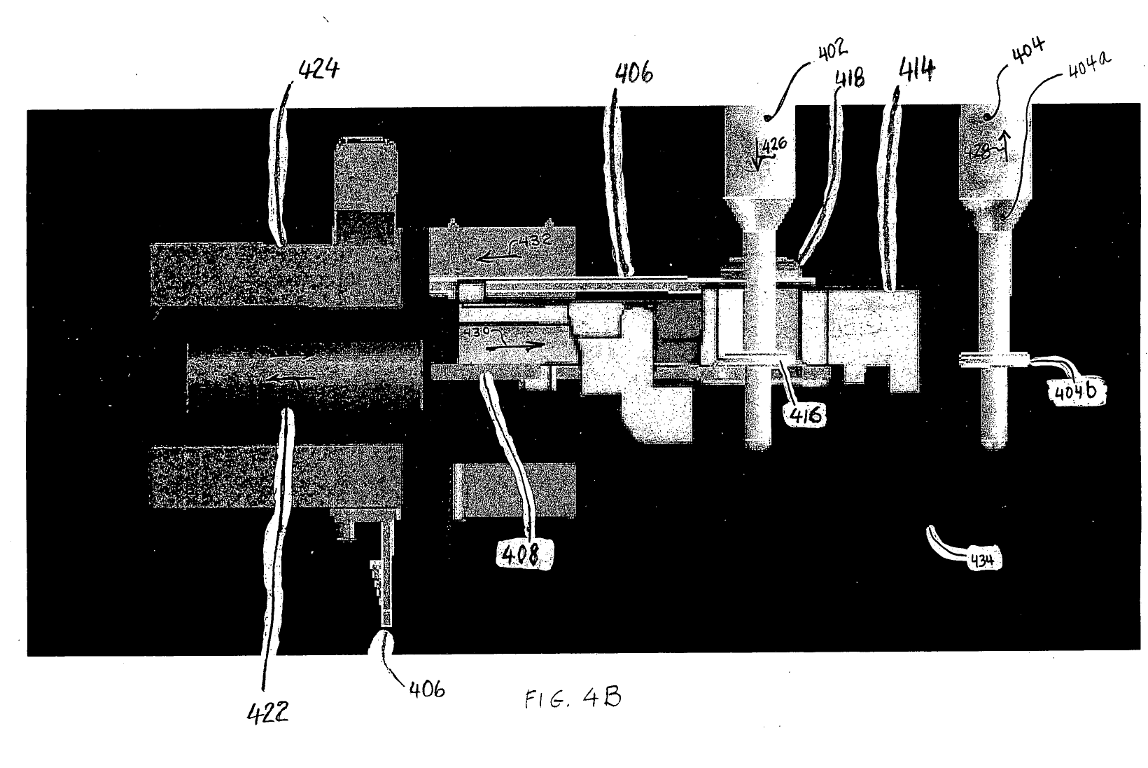

A tripping mechanism is included in the device, so that the device can be tripped prior to testing on a regular basis. When the user presses a test button (B2 of FIG. 3), on the outside of the device, switch SW4 is closed. (FIG. 4 shows how the metal test pin, attached to the test button, slides down and makes contact between two pins connected to the pc board—this arrangement forms SW4.) When SW4 is closed, current flows from load phase TP3 through resistors R7 and R8, through the LEDs 116, 118 of the optoisolator 120 and through resistor R6 to load neutral TP4. This causes the device to trip in the manner described above. When the device trips, current stops flowing through SW4, the optoisolator stops providing current to the gate of SC1 and SC1 turns off at the next zero crossing. When the test button B2 is released, SW4 opens again.

The electromechanical operation of the LCDI of the present invention is shown by FIGS. 3, 4, 4A and 4B. FIG. 3 shows the LCDI of the present invention comprising of a housing 300 having buttons B2 and B1 used to trip and reset the device respectively. At one end of housing 300 partial view of two of the plugs 304, 302 of the device can be seen. The third plug is not shown due to the particular orientation of the view of the plug as shown in FIG. 3. A power cord (not shown) connected to TP3, TP4, TP5 and TP9 as discussed above would extend from opening 306 of housing 300.

Referring to FIGS. 4, 4A and 4B there are shown some of the internal mechanical and electromechanical structures of the LCDI of the present invention. Pin 402 engages button B1 (see FIG. 3) when B1 is depressed. Attached to the end portion of pin 402 is a disk or circular flange 416 (see FIGS. 4A and 4B) that is dimensioned to pass through an opening 408a (see FIG. 4A) in latch 408 when said latch is appropriately positioned; that is, when the opening of the latch is properly aligned with the circular flange 416 and also aligned with opening 414a in lifter assembly 414 (see FIGS. 4A and 4B). Assuming the LCDI of the present invention is in the tripped mode, i.e., switch contacts SW2 and SW3 (FIG. 1) are open so that no power flows to the cord (i.e., connection points TP3 and TP4), then according to the LCDI of the present invention, the end portion of pin 302 is positioned above the latch 408. The device is thus in the tripped mode and can be reset by pressing B1. When B1 is depressed, it engages pin 402 causing pin 402 to be pushed in the direction shown by arrow 426; pin 402 is mechanically biased (through the use of a spring or through some other well known means) in the direction shown by arrow 428. At this point circular flange 416 is not aligned with the opening of latch 408 and thus the end portion of pin 402 interferes with a portion of the top surface of latch 408. Latch 408 being slidably mounted to lifter 414 will cause the lifter to move in the direction shown by arrow 426 closing mechanical switch SW1. Referring temporarily to FIG. 1, mechanical switch SW1 being closed creates a bias circuit consisting of resistors R1 and R4. Current flows through R1 and R4 which allows capacitor C1 to charge through resistor R2. When the voltage at the gate of SCR SC1 reaches the SCR's turn on voltage, the SCR turns ON allowing current to flow through coil L1 thus energizing L1 which is part of solenoid 120. Referring back to FIG. 4, the solenoid coil L1 is represented by coil 424 having plunger 422 residing therein. The energized coil 424 causes plunger 422 to move in the direction shown by arrow 430 which engages latch 408 causing said latch to move in the same direction (arrow 430) which at some point will have its opening 408a align with the circular flange 416. Note that plunger 422 is mechanically biased in the direction shown by arrow 432.

When the opening 408a of latch 403 is aligned with the circular flange 416 of pin 402, the bottom portion of pin 402 (including circular flange 416) passes through opening 408a. Immediately thereafter latch 408 springs back in the direction shown by arrow 432 thereby trapping circular flange 416 and the bottom portion of pin 402; this occurs because latch 408 is mechanically biased in the direction shown by arrow 432; plunger 422 is also mechanically biased in the direction shown by arrow 432. The opening 408a of latch 408 is thus no longer aligned with circular flange 416. When B1 is released with circular flange 416 being trapped under latch 408, the mechanical bias of pin 402 (mechanical bias direction shown by arrow 428) causes circular flange 416 to interfere with the bottom surface of latch 408 and the force of the bias of pin 408 causes the pin to move the lifter 414 in the direction shown by arrow 428 causing said lifter to engage movable arms 406 and 412 (represented by SW2 and SW3 in FIG. 1) each of which has a contact 418 and 420 respectively. The contacts of the movable arms 418 and 420 connects to corresponding receiving contacts (not shown) connected to points TP3 and TP4. The described action of the movable arms 418 and 420 correspond to switch contacts SW2 and SW3 being closed. The device is thus reset.

The device being now reset can be tripped in two ways: by pressing test button B2 or by the occurrence of an electrical fault. Regardless of which event causes the device to trip, the electromechanical operation is substantially the same. In particular, with the device in the reset mode, and B2 is depressed, the following occurs. B2 engages pin 404 which closes mechanical switch 410 (representing switch SW4 in FIG. 1). Mechanical switch 410 is an arrangement shown in FIG. 4 whereby the end portion of pin 404, which is metallic, is frictionally positioned between two pins thus electrically connecting these two pins to each other. The end of pin 404 and the two pins between which the end of pin 402 is frictionally situated form mechanical switch 410. Referring temporarily to FIG. 1, with switch 410 closed, current passes through resistors R7 and R8 to shield connection 106 through LEDs 116, 118 of optoisolator to connection 112, resistor R6 to connection 104 and thus TP4. As described above, as a result of this current flow, coil L1 is energized. Note that L1 can be energized also if an electric fault occurs as described above. Therefore, while in the reset mode, L1 can be energized because B2 is depressed or because an electrical fault occurs.

Referring back to FIGS. 4, 4A, and 4B with the LCDI device in the reset mode and coil L1 (represented as coil 424 in FIG. 4) being energized, plunger 422 moves in the direction shown by arrow 430 engaging latch 408 causing said latch to move in the direction shown by arrow 430. At some point in its movement, latch 408 will have its opening 408a aligned with the trapped circular flange 416 of pin 402. Circular flange 416 and the end portion of pin 402 heretofore trapped under latch 408 will escape once opening 408a of latch 408 is positioned to alignment by moving plunger 422. The bias of pin 402 causes the bottom portion and circular flange 416 to escape moving in the direction shown by arrow 428. Lifter 414 then moves in the direction shown by arrow 426 from the bias of the movable arms 406 and 412. With the movable arms moving down (in the direction shown by arrow 426), respective contacts 418 and 420 no longer make with the corresponding contacts (not shown) connected to TP3 and TP4 (see FIG. 1) thus opening switch contacts SW2 and SW3 (see FIG. 1) putting the device in a tripped condition.

The LCDI of the present invention can also be tripped mechanically. If the electrical trip mechanism described above fails, B2 can be depressed further to allow the shoulder 404a of pin 404 to engage with the hook or curved end of latch 408 (see FIG. 4). Shoulder 404a of pin 404 has a ramped profile and thus provides a cam relationship between pin 404 and latch 408. In particular as B2 is further depressed allowing shoulder 404a to engage the inner portion of the hook end of latch 408, the latch 408 is caused to move in the direction shown by arrow 430 due to the angled or ramped profile of shoulder 408a; thus the motion of pin 404 as shown by arrow 426 is converted to a motion of latch 408 in the direction shown by arrow 430. Circular flange 404b of pin 404 defines how much distance pin 404 is allowed to travel so that shoulder 404a engages latch 408. As pin 404a is depressed further, its motion in the direction shown by arrow 426 will at some point be stopped by the circular flange 404b contacting support component 434.

As latch 408 is moved in the direction shown by arrow 430, its opening 408a aligns with the trapped circular flange 416 allowing such flange 416 and the end portion of pin 402 to escape tripping the device as discussed above. Therefore, a user of the device of the present invention has the option of mechanically tripping the device if said user has discovered that the electrical trip mechanism has failed. It should also be noted that the LCDI of the present invention has a reset lockout arrangement in that if any of the electrical, mechanical or electromechanical parts of the tripping and or resetting mechanism is not functioning, the device cannot be reset. That is, when the device is tripped, if any one or more of the components (mechanical, electrical or electromechanical) used to trip the device is not working properly, the device cannot be reset. For example, if the device has been tripped and thereafter the optoisolator malfunctions, pressing B1 will not reset the device because the plunger 422 will not move due to the coil 424 not being energized. The coil 424 is not energized because SC1 is not turned ON and this is because no turn on voltage exists at its gate because transistor 122 is not turned ON.

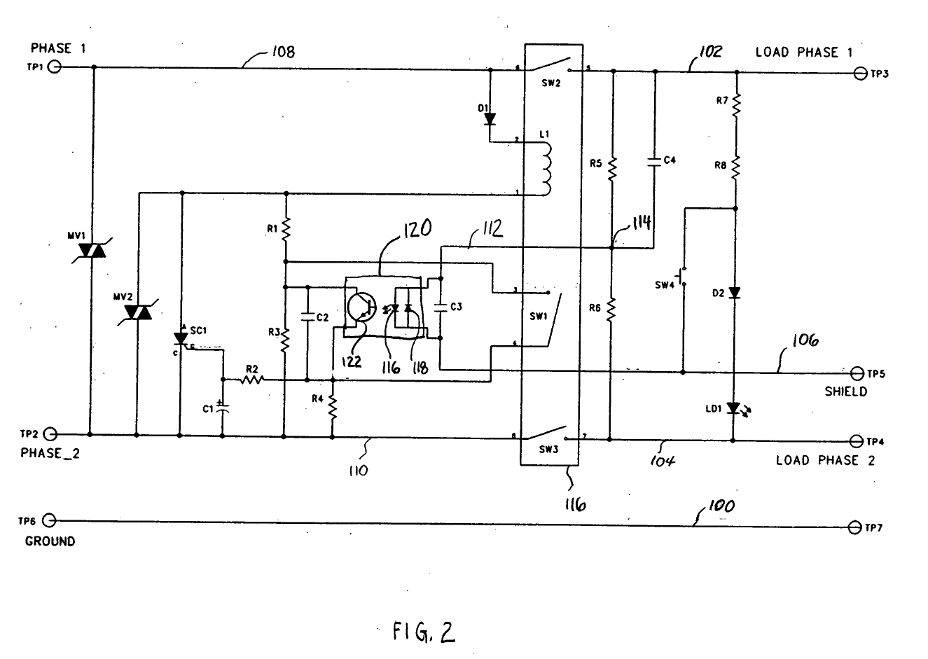

FIG. 2 shows the circuit diagram of the 240V version of the LCDI. In the United States, the power for 240V circuits is provided by two phase (or live) wires. The two phase wires connected to connection points TP1 and TP2 are so designated in FIG. 2. Ground connected to point TP6 has a potential that lies directly in between the two phases: 120V from each phase. This means that the potential of the shield TP5 cannot be held at a point directly between the two phases, otherwise leakage current from the ground would not be detected. To create an offset from ground the value of resistor R5 does not equal the value of resistor R6. In addition, both R5 and R6 are increased in value to limit the steady state current at this higher supply voltage.

Some other distinctions between the 12V and 240V version of the LCDI of the present invention are as follows. To increase sensitivity to leakage from ground, the current-boosting capacitor C4 is added. Capacitor C4 works in the following way: when the shield initially comes into contact with the ground TP7, capacitor C4 dumps current through the LEDs of optoisolator 120 through R9 and the shield to ground in an attempt to keep the voltage across itself the same. Thus, ground leakage can be detected with only a relatively small offset between shield and ground.

In the 240V version, the values of resistors R7 and R8 are increased to keep the current through LED LD1 comparable to the 120V version. The value of resistor R1 is increased to keep the voltage across the transistor 122 in the optoisolator 120 comparable to that in the 120V version.

Also, by increasing the value of R1 even further (or by increasing the value of R2) the time at which SCR SC1 turns ON can be delayed until later in the positive half cycle. This means that the same trip coil L1 can be used in the 240V, as in the 120V version, because their power dissipation is comparable. More current flows through the coil in the 240V version, but it is on for a shorter time. Common to both versions of the LCDI of the present invention are the provision of two Metal Oxide Varistors (MOVs) MV1 and MV2 which provide protection from voltage spikes on the line side of the LCDI. The inductance of coil L1 also protects the device from line voltage spikes. Capacitor C2 provides further protection of the transistor in the optoisolator as well as preventing the transistor 122 from being turned ON by relatively high frequency noise. LED LD1 is lit when switch contacts SW2 and SW3 are closed and is extinguished when these contacts are open. Diode D2 provides a DC power supply to LED LD1 with resistors R7 and R8 limiting the current flowing through LD1. LD1 thus indicates when power is being supplied to the power cord of the LCDI of the present invention.

1. A circuit interrupting device comprising:
a detection portion;
an interrupting portion;
a nonconductive coupling device coupled to both the detection portion and the interrupting portion such that a fault signal generated by the detection portion from the detection of an electric fault is transferred from the detection portion to the interrupting portion in a nonconductive manner allowing the interrupting portion to trip the device.

2. The circuit interrupting device of claim 1 where the fault signal is generated based on a first threshold and the device is tripped based on a second threshold where the first and second threshold are set independently of each other.

3. The circuit interrupting device of claim 1 where the interrupting portion uses an electromechanical tripping mechanism to trip the device.

4. The circuit interrupting device of claim 1 where the interrupting portion uses a mechanical tripping mechanism to trip the device.

5. The circuit interrupting device of claim 1 further comprising a reset portion for resetting the device after the interrupting portion has tripped the device.

6. A method of operating a circuit interrupting device, the method comprising the step of:
tripping the device in its reset state based on a second threshold when a fault is detected based on a first threshold and where the first and second thresholds are set independently of each other.
